(19) United States
(12) Patent Application Publication
(10) Pub. No.: US 2026/0006537 A1
(43) Pub. Date: Jan. 1, 2026

(54) ENHANCED UNKNOWN SECONDARY CELL ACTIVATION FOR WIRELESS COMMUNICATIONS

(71) Applicant: INTEL CORPORATION, Santa Clara, CA (US)

(72) Inventors: Hua LI, Beijing (CN); Meng ZHANG, Beijing (CN); Rui HUANG, Bejing (CN); In-Seok HWANG, Santa Clara, CA (US); Richard BURBRIDGE, Oxfordshire (GB)

(73) Assignee: INTEL CORPORATION, Santa Clara, CA (US)

(21) Appl. No.: 18/881,260

(22) PCT Filed: Aug. 2, 2023
(86) PCT No.: PCT/US2023/029335

§ 371 Date: Jan. 3, 2025

Related U.S. Application Data
(60) Provisional application No. 63/394,910, filed on Aug. 3, 2022.
(60) Provisional application No. 63/411,437, filed on Sep. 29, 2022.

(51) Int. Cl. H04W 48/16; H04B 7/06; H04W 24/08; H04W 24/10

(52) U.S. Cl. CPC H04W 48/16; H04B 7/06952; H04W 24/08; H04W 24/10

(57) ABSTRACT

This disclosure describes systems, methods, and devices for secondary cell activation. A device may decode a medium access control (MAC) control element received from a network node, the MAC control element including a request to activate a secondary cell (SCell); perform receiver beam sweeping using a beam sweeping factor less than eight in a frequency range prior to activating the SCell, the receiver beam sweeping including: automatic gain control using the beam sweeping factor; and searching for the SCell using the beam sweeping factor; encode a reference signal received power (RSRP) report to be transmitted, the RSRP report including a synchronization signal block (SSB) prior to activating the SCell; perform a channel status information measurement prior to activating the SCell; encode a report indicative of the channel status information measurement to be transmitted prior to activating the SCell; and activate the SCell.

### CROSS-REFERENCE TO RELATED PATENT APPLICATION(S)

This application claims the benefit of U.S. Provisional Application No. 63/411,437, filed Sep. 29, 2022, and U.S. Provisional Application No. 63/394,910, filed Aug. 3, 2022, the disclosures of which are incorporated herein by reference as if set forth in full.

### TECHNICAL FIELD

This disclosure generally relates to systems and methods for wireless communications and, more particularly, to unknown secondary cell activation.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is a network diagram illustrating an example network environment, in accordance with one or more example embodiments of the present disclosure.

FIG. 2 illustrates example processes associated with secondary cell (SCell) activation time delay for an unknown SCell in frequency range 2, in accordance with one or more example embodiments of the present disclosure.

FIG. 3 illustrates example processes associated with SCell activation time delay for an unknown SCell, in accordance with one or more example embodiments of the present disclosure.

FIG. 4 illustrates a flow diagram of illustrative process for unknown SCell activation, in accordance with one or more example embodiments of the present disclosure.

FIG. 5 illustrates a network, in accordance with one or more example embodiments of the present disclosure.

FIG. 6 schematically illustrates a wireless network, in accordance with one or more example embodiments of the present disclosure.

FIG. 7 is a block diagram illustrating components, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may operate as defined by technical standards. For cellular telecommunications, the 3^{rd} Generation Partnership Program (3GPP) define communication techniques, including for secondary cell activation. In 3GPP, a primary cell may refer to a cell operating in a primary frequency in which a user equipment (UE) either performs the initial connection establishment procedure or initiates the connection re-establishment procedure, or the cell indicated as the primary cell in the handover procedure. A secondary cell may refer to a cell operating in a secondary frequency, which may be configured once an RRC connection is established and which may be used to provide additional radio resources.

Secondary cell (SCell) activation is used in 3GPP communications to activate or deactivate data transmission for the SCell. Upon receiving a SCell activation/deactivation command, the UE may activate/deactivate the SCell, but sometimes with significant time delay (e.g., in milliseconds, depending on if the SCell is known and belongs to frequency range 1:410-725 MHz, if the SCell is unknown and belongs to frequency range 1, if the SCell belongs to frequency range 2:24250-52600 MHZ, and other conditions) associated with multiple steps performed prior to the SCell activation.

When the UE receives a SCell activation command (e.g., in a PDSCH sent by the network) for a SCell ending in slot n, the UE performs multiple actions that may be included in the time delay for SCell activation.

In 3GPP legacy unknown SCell activation in frequency range 2 (FR2), the total delay can be significant, involving both layer 1 (L1) and layer 3 (L3) measurements. However, some schemes can be further improved to simply the SCell activation procedure.

Embodiments of the present disclosure relate to enhancement for L1 measurement and L3 measurement, respectively. Specifically, embodiments herein relate to a SCell activation improvement scheme to reduce delay in L1 and L3 measurements.

In addition, in 3GPP RAN96, the WID about FR2 SCell activation delay reduction is shown below:
FR2 SCell activation delay reduction:
   Identify cases where FR2 SCell activation delay can be reduced (e.g., unknown target cell cases), and specify reduced delay requirements for such cases, including but not limited to [RAN4].
   Study and, if feasible, enhance cell detection for unknown SCell and time/frequency tracking.
   Study and, if feasible, enhance L1-RSRP measurement delay reduction on target SCell.
   Note: Subject to RAN4's agreement, the technical solutions can be extended to other general RRM requirements if applicable.
   Specify if needed, reference signal enhancement and/or signaling enhancement for the UE to meet the enhanced delay requirements [RAN4, RAN2].
   Note: No RAN1 work, i.e. introducing new RS, is expected.
   Note: the technical solutions can be extended to FR1, when applicable.

There is therefore a need to design a new FR2 SCell activation delay reduction scheme.

In one or more embodiments, in unknown FR2 SCell activation, the delay includes multiple steps:
1) Application of SCell activation medium access control (MAC) control element (CE).
2) Cell detection, in order to find coarse timing of the SCell, and
3) Automatic gain control (AGC), in order to settle the gain setting for the SCell, and
4) L1-reference signal received power (RSRP) measurement and reporting, in order to find receive (Rx) beam for receiving and help the network to select transmit (Tx) beam.
5) Application of the physical downlink control channel (PDCCH) transmission configuration indicator (TCI) activation MAC CE or channel status information (CSI) resource activation command.
6) Fine time tracking.
7) Channel quality index (CQI) measurement and reporting.

The SCell activation behaviour can be improved. Two steps are involved in L3 related procedure: Cell detection and AGC.

One SSB for cell search and two SSB for AGC are assumed. During the L3 procedure, Rx beam sweeping will be performed, i.e. N. Since the RX beam sweeping factor is 8, the total 3*8=24 SMTC is assumed, and Rx beam sweeping factor N can be improved. A new UE capability can be introduced to further reduce the FR2 RX beam sweeping factor to be less than 8, e.g. {1,2,4,6}.

Another aspect is to further reduce the sample number used for AGC and cell search.

For the cell search part, 1*8 samples will be used for FR2. However, rough timing corresponding to different RX beam may not differ significantly. Therefore, M total samples may be sufficient (e.g., M<8), and M is independent of the Rx beam sweeping factor.

For the AGC part, the total delay may be scaled by the Rx beam sweeping factor because the beam power may be significantly different. In addition, due to the higher channel quality, two samples can be further reduced to one sample.

One option is that the delay for cell search and AGC are defined separately and summed together:

Delay for cell search is M*Trs.

Delay for AGC is N*2*Trs or N*1*Trs.

The total delay is M*Trs+N*2*Trs or M*Trs+N*1*Trs, where N is the Rx beam sweeping factor, and Trs is RS periodicity.

Another option is that only total delay is defined and it is the responsibility of the UE to dynamically share the total time for cell search and AGC.

There are possible enhancements for the L1 part. In legacy unknown SCell activation, beam reporting is based on L1-RSRP measurement. It is possible that L1-RSRP can be skipped and that a L3 measurement can be used for beam reporting.

For the known SCell case, the report SSB index is also based on the L3 measurement, and the TCI state is selected based on one of the latest reported SSB indexes. The known condition for FR2 is defined below in TS 38.133:

For the first SCell activation in FR2 bands, the SCell is known if it has been meeting the following conditions:
During the period equal to 4 s for UE supporting power class 1/5 and 3 s for UE supporting power class 2/3/4 before UE receives the last activation command for PDCCH TCI, PDSCH TCI (when applicable) and semi-persistent CSI-RS for CQI reporting (when applicable):
The UE has sent a valid L3-RSRP measurement report with SSB index
SCell activation command is received after L3-RSRP reporting and no later than the time when UE receives MAC-CE command for TCI activation
During the period from L3-RSRP reporting to the valid CQI reporting, the reported SSBs with indexes remain detectable according to the cell identification conditions specified in clauses 9.2 and 9.3 of TS 38.133, and the TCI state is selected based on one of the latest reported SSB indexes.

It shows that for known case, L3-RSRP measurement will be reported with SSB index and TCI state is selected based on L3 report.

For the unknown SCell case, for cell detection and AGC steps, Rx beam sweeping will still be applied and may be possible to the derive L3 measurement result and determine the best Rx beam to report SSB index.

Therefore, the L1-RSRP measurement can be skipped for the unknown SCell case, and the L3 measurement result can be used for beam-related measurement reporting, which is aligned with known case procedure for SCell activation.

The next questions are whether TCI activation and fine timing tracking are still needed or not.

If UE has already reported the best TX beam with SSB index, the UE can assume to use the same reported beam assumption for the following PDCCH and CQI measurement. Therefore, UE does not need to wait for the MAC CE based TCI activation. This does not preclude the network (NW) from sending a new TCI activation command to switch the beam.

When a new TCI activation command is received by the UE, the beam will be changed, and fine tracking plus 2 ms margin needs to be performed.

When TCI activation is skipped, fine time tracking is still needed even through no beam will be changed.

Similar to 3GPP legacy processing of HO, PSCell addition, after L3 measurement, fine timing tracking will be applied to prepare for data transmission. Fine time tracking may be skipped and the timing may be derived from a L3 measurement.

In summary, the procedure is as below:
1) SCell activation MAC CE && CSI configuration/activation command.
2) AGC with reduced Rx beam sweeping factor.
3) Cell detection with reduced Rx beam sweeping factor.
4) L3-RSRP reporting with SSB index.
5) TCI activation (can be skipped).
6) Fine time tracking (can be skipped).
7) CSI measurement and reporting.

In one or more embodiments, a beam-related enhancement to the L3 part of SCell activation may address the issue of whether X1 (e.g., representing a number of a candidate beam for the UE to measure) can be zero. X1=1 may be a candidate value for the beam sweeping factor in the L3 part for FR2 unknown SCell activation. X1 may be greater than zero and less than eight in another option. Another beam-related enhancement may address the beam sweeping factor in L3 and L1 parts of the FR2 unknown SCell activation. X1 may be 1, 2, 4, or 6; X2 may be an integer from 0-7; if X1 is absent, the beam sweeping factor for cell detection may be 8; if X2 is absent, the beam sweeping factor for SSB-based L1 measurement may be 8.

In legacy Rel-15 FR2 SCell activation, the T_{activation_time} is defined based on 4 scenarios:

Scenario 1: at least one active serving cell on that FR2 band, SMTC of target SCell is provided.

Scenario 2: at least one active serving cell on that FR2 band, No SMTC is not provided.

Scenario 3: No active serving cell on that FR2 band, target SCell is known.

Scenario 4: No active serving cell on that FR2 band, target SCell is unknown.

The scenarios are shown below in Table 1.

TABLE 1
Activation Time Scenarios for SCell Activation

| SCell | | | |
|---|---|---|---|
| activation on | | | |
| FR2 | Scenario | Delay | Procedure |
| at least one | scenario 1: | T_{firstSSB} + 5 ms | No AGC and one fine |
| active serving | SMTC of target | | timing acquisition is |
| cell on that | SCell is provided | | required. |
| FR2 band | scenario 2: | 3 ms | No AGC and fine |
| | No SMTC is not | | timing acquisition are |
| | provided | | required. |
| No active | scenario 3: | semi-persistent CSI-RS is used for | TCI activation and fine |
| serving cell on | target SCell is | CSI reporting: | time tracking are |
| that FR2 band | known | 3 ms + max(T_{uncertainty}_{_{—}}_{MAC} + | considered. |
| | | T_{FineTiming} + 2 ms, T_{uncertainty}_{_{—}}_{SP}) | |
| | | periodic CSI-RS is used for | |
| | | CSI reporting: | |
| | | max(T_{uncertainty}_{_{—}}_{MAC} + 5 ms + | |
| | | T_{FineTiming}, T_{uncertainty}_{_{—}}_{RRC} + T_{RRC}_{_{—}}_{delay} − | |
| | | T_{HARQ}) | |
| | scenario 4: | semi-persistent CSI-RS is | cell detection, AGC, |
| | target SCell is | used for CSI reporting: | beam sweeping, TCI |
| | unknown | 6 ms + T_{FirstSSB}_{_{—}}_{MAX} + | activation, CSI |
| | | 15*T_{SMTC}_{_{—}}_{MAX} + 8*Tᵣₛ + T_{L1-RSRP, measure} + | activation/configuration |
| | | T_{L1-RSRP, report} + T_{HARQ} + | |
| | | max(T_{uncertainty}_{_{—}}_{MAC} + T_{FineTiming} + | |
| | | 2 ms, T_{uncertainty}_{_{—}}_{SP}) | |
| | | periodic CSI-RS is used for | |
| | | CSI reporting: | |
| | | 3 ms + T_{FirstSSB}_{_{—}}_{MAX} + 15*_{TSMTC}_{_{—}}_{MAX} + | |
| | | 8*Tᵣₛ + T_{L1-RSRP, measure} + T_{L1-RSRP, report} + | |
| | | max {(T_{HARQ} + | |
| | | T_{uncertainty}_{_{—}}_{MAC} + 5 ms + T_{FineTiming}), | |
| | | (T_{uncertainty}_{_{—}}_{RRC} + T_{RRC}_{_{—}}_{delay})} | |

For scenarios 1 and 2, the delays are short and may not need extra delay reduction.

For scenario 3, even though the UE has sent a L3 measurement before receiving a SCell activation command, the UE will not maintain the result as the SCell is deactivated. Therefore, TCI activation is still needed. There is no need to further reduce delay for TCI activation. However, since the total delay will also depend on the maximum delay between TCI activation delay and CSI activation delay, i.e. max (T_{uncertainty_MAC}+T_{FineTiming}+2 ms, T_{uncertainty_SP}) for SP CSI and max {(T_{HARQ}+T_{uncertainty_MAC}+5 ms+T_{FineTiming}), (T_{uncertainty_RRC}+T_{RRC_delay})} for periodic CSI. Besides, CSI-RS activation/configuration delay will have impact on the unknown SCell case either. Therefore, it may be needed to further reduce CSI activation/configuration delay, e.g. semi-persistent CSI-RS activation or RRC based CSI configuration command can be sent with SCell activation command together or can be sent within X ms after a SCell activation command is sent.

Therefore, for scenario 3, if semi-persistent CSI-RS activation or a RRC-based CSI configuration command can be sent with a SCell activation command together, the SCell activation delay when semi-persistent CSI-RS or periodic CSI-RS is used for CSI reporting is as follows:

$$3 ms + {T}_{uncertainty \_ MAC} + {T}_{FineTiming} + 2 ms$$

For scenario 4, because the target SCell is unknown, many actions may be involved, which are as follows:

In unknown case, UE needs to perform the following actions:
1) Application of SCell activation MAC CE,
2) Cell detection, in order to find coarse timing of the SCell, and
3) AGC, in order to settle the gain setting for the SCell, and
4) L1-RSRP measurement and reporting, in order to find Rx beam for receiving and help the network to select Tx beam,
5) Application of the PDCCH TCI activation MAC CE,
6) Fine time tracking, and
7) CQI measurement and reporting.

For actions 2 and 3 above by the UE, 1 SSB for cell search and 2 SSB for AGC are assumed. Since the RX beam sweeping factor is 8, therefore total 3*8=24 SMTC is assumed.

For action 4, L1-RSRP measurement will also be dependent on the Rx beam sweeping factor.

For FR2 SCell activation, if SCell is unknown, RX beam sweeping factor will have great impact on cell search time, AGC time and L1-RSRP measurement. In Rel-18, RX beam sweeping factor can be reduced.

Actions 5 and 6 are related to TCI activation. Because in action 4, UE has already performed L1-RSRP measurement. If UE report the best TX beam with SSB index, the UE can assume to use the same beam assumption for the following PDCCH and CQI measurement. Therefore, UE does not need to wait for the MAC CE based TCI activation and perform fine time tracking.

For FR2 SCell activation, if SCell is unknown, UE may assume to use the best reported beam for the following PDCCH and CQI measurement to reduce the delay. TCI activation delay will be reduced.

Besides, the semi-persistent CSI-RS activation or RRC based CSI configuration delay will also have impact on the total delay. if TCI activation skipped, the total delay will include the delay of SP CSI-RS activation or RRC based CSI configuration. If the delay is too long, e.g. larger than TCI activation delay, there is no delay reduction even if TCI activation is skipped.

Therefore, it may be desirable to reduce the semi-persistent CSI-RS activation or RRC based CSI configuration delay. Similar with scenario 3, one possible solution is that semi-persistent CSI-RS activation or RRC based CSI configuration command can be sent with SCell activation command together, while this will require the signalling update in RAN2. Another option is that semi-persistent CSI-RS activation or RRC based CSI configuration command can be sent within X ms after scell activation command is sent.

If semi-persistent CSI-RS activation can be sent with SCell activation command together and TCI activation command is skipped, the delay is:

$$6 ms + {T}_{FirstSSB \_ MAX} + 15 * {T}_{SMTC \_ MAX} + 8 * {T}_{rs} + {T}_{L 1 - RSRP , measure} + {T}_{L 1 - RSRP , report} + {T}_{HARQ} .$$

If RRC based CSI-RS configuration command can be sent with SCell activation command together and TCI activation command is skipped, the delay is as follows:

$$3 ms + {T}_{FirstSSB \_ MAX} + 15 * {T}_{SMTC \_ MAX} + 8 * {T}_{rs} + {T}_{L 1 - RSRP , measure} + {T}_{L 1 - RSRP , report} .$$

The component T_{FirstSSB_MAX}+15*T_{SMTC_MAX}+8*Tᵣₛ+T_{L1-RSRP}, measure can be further reduced if RX beam factor is reduced.

For FR1 unknown target SCell case, similarly, UE will wait for TCI activation and fine time tracking as well. It's still possible that UE can assume TCI state by using the reported L1-RSRP result. If semi-persistent CSI-RS activation or RRC based CSI-RS configuration delay can be reduced, the same method for FR2 can be applied to FR1 as well.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

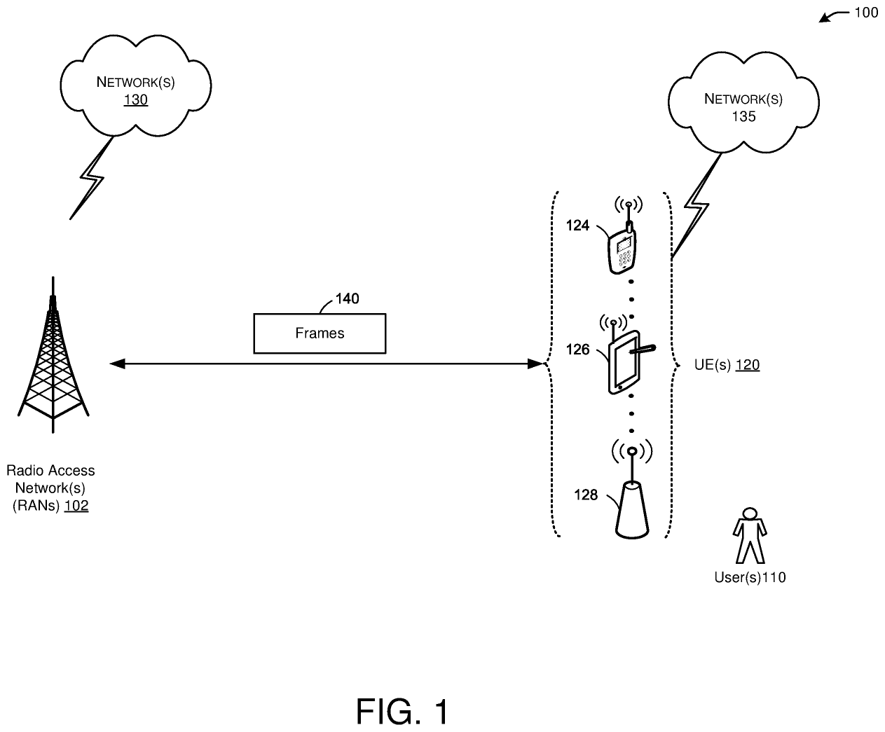

FIG. 1 is a network diagram illustrating an example network environment 100, in accordance with one or more example embodiments of the present disclosure.

Wireless network 100 may include one or more UEs 120 and one or more RANs 102 (e.g., gNBs), which may communicate in accordance with 3GPP communication standards. The UE(s) 120 may be mobile devices that are non-stationary (e.g., not having fixed locations) or may be stationary devices.

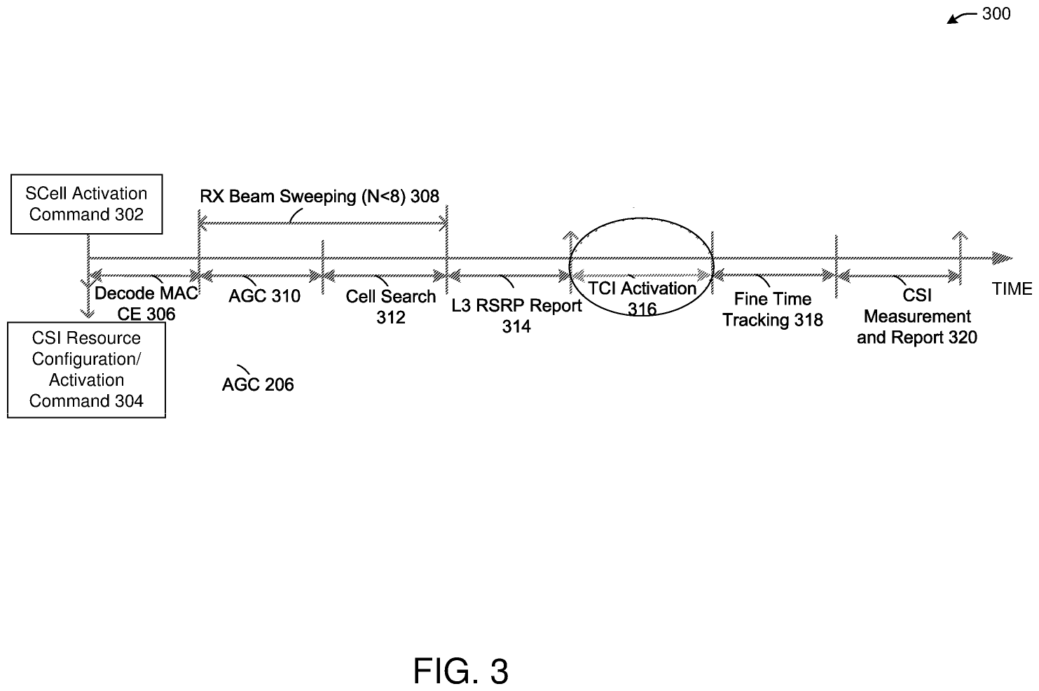

In some embodiments, the UEs 120 and the RANs 102 may include one or more computer systems similar to that of FIGS. 3-5.

One or more illustrative UE(s) 120 and/or RAN(s) 102 may be operable by one or more user(s) 110. A UE may take on multiple distinct characteristics, each of which shape its function. For example, a single addressable unit might simultaneously be a portable UE, a quality-of-service (QoS) UE, a dependent UE, and a hidden UE. The UE(s) 120 (e.g., 124, 126, or 128) and/or RAN(s) 102 may include any suitable processor-driven device including, but not limited to, a mobile device or a non-mobile, e.g., a static device. For example, UE(s) 120 may include, a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

Any of the UE(s) 120 (e.g., UEs 124, 126, 128), and UE(s) 120 may be configured to communicate with each other via one or more communications networks 130 and/or 135 wirelessly or wired. The UE(s) 120 may also communicate peer-to-peer or directly with each other with or without the RAN(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, cellular networks. In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the UE(s) 120 (e.g., UE 124, 126, 128) and RAN(s) 102 may include one or more communications antennas. The one or more communications antennas may be any suitable type of antennas corresponding to the communications protocols used by the UE(s) 120 (e.g., UEs 124, 126 and 128), and RAN(s) 102. Some non-limiting examples of suitable communications antennas include cellular antennas, 3GPP family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the UEs 120 and/or RAN(s) 102.

Any of the UE(s) 120 (e.g., UE 124, 126, 128), and RAN(s) 102 may be configured to perform directional transmission and/or directional reception in conjunction with wirelessly communicating in a wireless network. Any of the UE(s) 120 (e.g., UE 124, 126, 128), and RAN(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the UE(s) 120 (e.g., UE 124, 126, 128), and RAN(s) 102 may be configured to perform any given directional transmission towards one or more defined transmit sectors. Any of the UE(s) 120 (e.g., UE 124, 126, 128), and RAN(s) 102 may be configured to perform any given directional reception from one or more defined receive sectors.

MIMO beamforming in a wireless network may be accomplished using RF beamforming and/or digital beamforming. In some embodiments, in performing a given MIMO transmission, UE 120 and/or RAN(s) 102 may be configured to use all or a subset of its one or more communications antennas to perform MIMO beamforming.

Any of the UE 120 (e.g., UE 124, 126, 128), and RAN(s) 102 may include any suitable radio and/or transceiver for transmitting and/or receiving radio frequency (RF) signals in the bandwidth and/or channels corresponding to the communications protocols utilized by any of the UE(s) 120 and RAN(s) 102 to communicate with each other. The radio components may include hardware and/or software to modulate and/or demodulate communications signals according to pre-established transmission protocols. The radio components may further have hardware and/or software instructions to communicate via one or more 3GPP protocols and using 3GPP bandwidths. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one or more embodiments, and with reference to FIG. 1, one or more of the UEs 120 may exchange frames 140 with the RANs 102. The frames 140 may include UL and DL frames. In some examples, the frames 140 may include commands (e.g., MAC CEs or otherwise) that request SCell activation/deactivation by the one or more of the UEs 120. The frames 140 may be part of RX and/or TX beam sweeping at the UEs 120, and may include signaling to the RANs 102 indicating SCell activation/deactivation (e.g., including the SCell activated/deactivated).

It is understood that the above descriptions are for purposes of illustration and are not meant to be limiting.

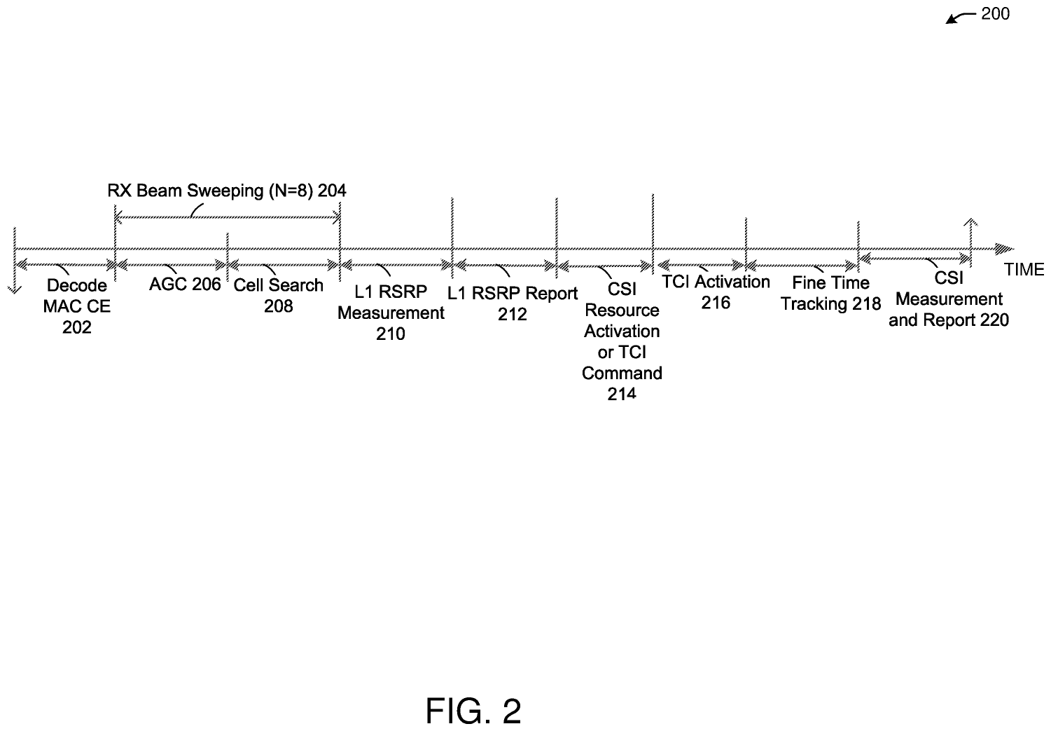

FIG. 2 illustrates example processes 200 associated with SCell activation time delay for an unknown SCell in frequency range 2, in accordance with one or more example embodiments of the present disclosure.

At step 202, a UE may decode a MAC CE (e.g., received from a RAN/gNB). At step 204, the UE may perform RX beam sweeping with N=8. Step 204 may include AGC 206 and a cell search 208 (e.g., SCell search). Step 210 may include a layer-one (L1) measurement by the UE. Step 212 may include encoding a L1 RSRP report for transmission. Step 214 may include resolving a CSI resource activation or TCI command (e.g., an uncertainty). Step 216 may include TCI activation. Step 218 may include fine time tracking. Step 220 may include the UE performing a CSI measurement and encoding the CSI measurement into a report.

FIG. 3 illustrates example processes 300 associated with SCell activation time delay for an unknown SCell, in accordance with one or more example embodiments of the present disclosure.

At step 302, a UE may decode a SCell activation command. At step 304, the UE may decode a CSI configuration/activation command. At step 306, the EU may decode a MAC CE (e.g., received from a RAN/gNB). At step 308, the UE may perform RX beam sweeping with N<8. Step 308 may include AGC 310 and a cell search 312 (e.g., SCell search). Step 314 may include encoding a L3 RSRP report for transmission. Step 316 may include TCI activation (an optional step that can be skipped based on network configuration). Step 318 may include fine time tracking (an optional step that can be skipped based on network configuration). Step 320 may include performing a CSI measurement and encoding the CSI measurement into a report.

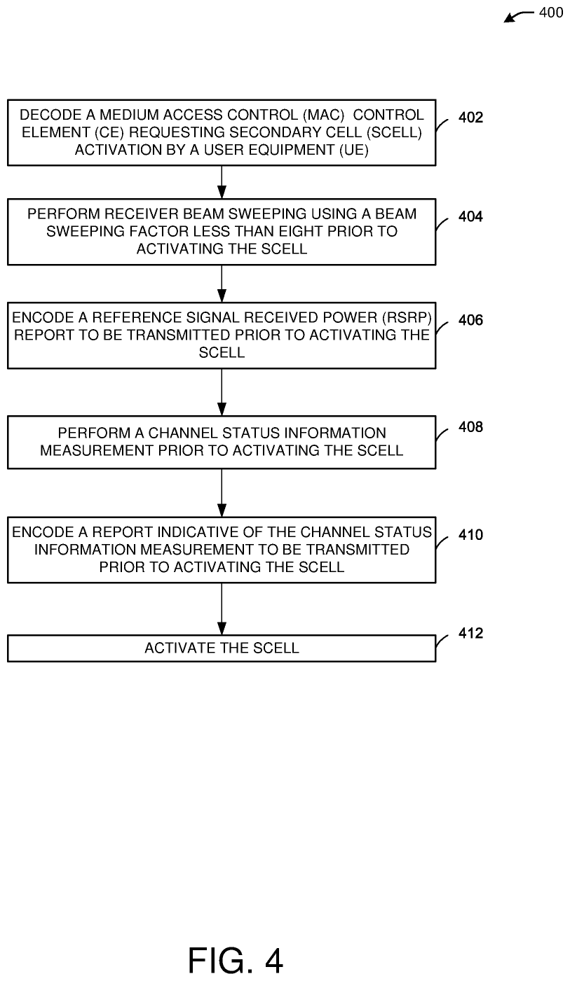

FIG. 4 illustrates a flow diagram of illustrative process 400 for unknown SCell activation, in accordance with one or more example embodiments of the present disclosure.

At block 402, a device (e.g., the UE 120 of FIG. 1) may decode a MAC CE requesting SCell activation by the UE.

At block 404, the device may perform Rx beam sweeping using a beam sweeping factor less than eight prior to activating the SCell.

At block 406, the device may encode a RSRP report to be transmitted prior to activating the SCell.

At block 408, the device may perform a CSI measurement prior to activating the SCell.

At block 410, the device may encode a report indicative of the CSI measurement to be transmitted prior to activating SCell.

At block 412, the device may activate the SCell.

These embodiments are not meant to be limiting.

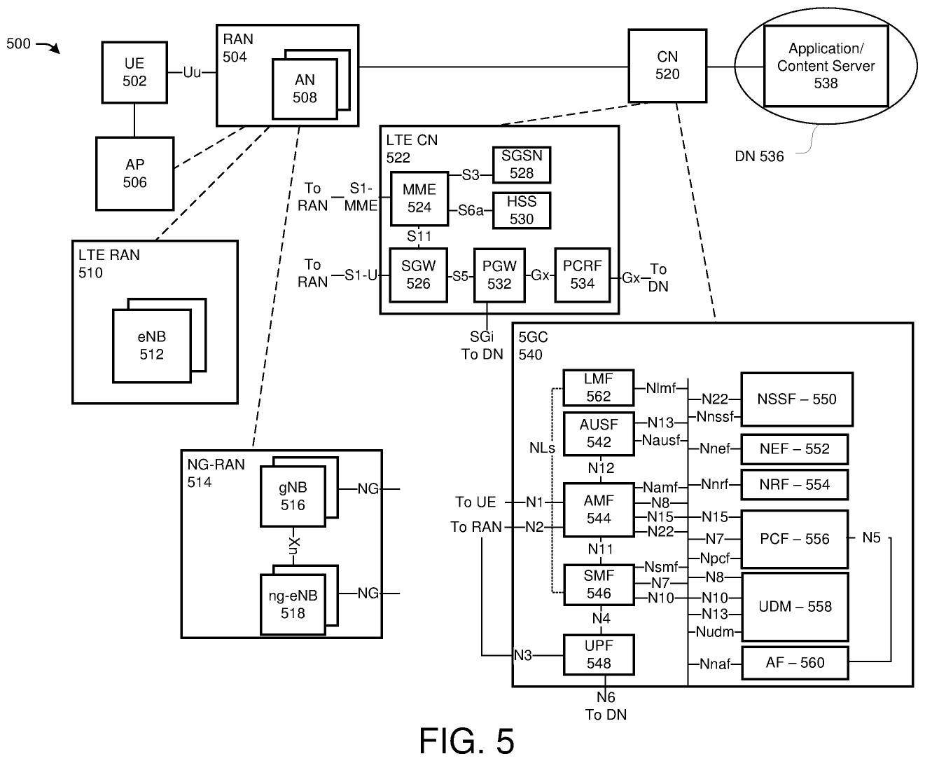

FIG. 5 illustrates a network 500 in accordance with various embodiments. The network 500 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 500 may include a UE 502, which may include any mobile or non-mobile computing device designed to communicate with a RAN 504 via an over-the-air connection. The UE 502 may be communicatively coupled with the RAN 504 by a Uu interface. The UE 502 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 500 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 502 may additionally communicate with an AP 506 via an over-the-air connection. The AP 506 may manage a WLAN connection, which may serve to offload some/all network traffic from the RAN 504. The connection between the UE 502 and the AP 506 may be consistent with any IEEE 802.11 protocol, wherein the AP 506 could be a wireless fidelity (Wi-Fi®) router. In some embodiments, the UE 502, RAN 504, and AP 506 may utilize cellular-WLAN aggregation (for example, LWA/LWIP). Cellular-WLAN aggregation may involve the UE 502 being configured by the RAN 504 to utilize both cellular radio resources and WLAN resources.

The RAN 504 may include one or more access nodes, for example, AN 508. AN 508 may terminate air-interface protocols for the UE 502 by providing access stratum protocols including RRC, PDCP, RLC, MAC, and L1 protocols. In this manner, the AN 508 may enable data/voice connectivity between CN 520 and the UE 502. In some embodiments, the AN 508 may be implemented in a discrete device or as one or more software entities running on server computers as part of, for example, a virtual network, which may be referred to as a CRAN or virtual baseband unit pool. The AN 508 be referred to as a BS, gNB, RAN node, eNB, ng-eNB, NodeB, RSU, TRxP, TRP, etc. The AN 508 may be a macrocell base station or a low power base station for providing femtocells, picocells or other like cells having smaller coverage areas, smaller user capacity, or higher bandwidth compared to macrocells.

In embodiments in which the RAN 504 includes a plurality of ANs, they may be coupled with one another via an X2 interface (if the RAN 504 is an LTE RAN) or an Xn interface (if the RAN 504 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 504 may each manage one or more cells, cell groups, component carriers, etc. to provide the UE 502 with an air interface for network access. The UE 502 may be simultaneously connected with a plurality of cells provided by the same or different ANs of the RAN 504. For example, the UE 502 and RAN 504 may use carrier aggregation to allow the UE 502 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 504 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 502 or AN 508 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 504 may be an LTE RAN 510 with eNBs, for example, eNB 512. The LTE RAN 510 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 504 may be an NG-RAN 514 with gNBs, for example, gNB 516, or ng-eNBs, for example, ng-eNB 518. The gNB 516 may connect with 5G-enabled UEs using a 5G NR interface. The gNB 516 may connect with a 5G core through an NG interface, which may include an N2 interface or an N3 interface. The ng-eNB 518 may also connect with the 5G core through an NG interface, but may connect with a UE via an LTE air interface. The gNB 516 and the ng-eNB 518 may connect with each other over an Xn interface.

In some embodiments, the NG interface may be split into two parts, an NG user plane (NG-U) interface, which carries traffic data between the nodes of the NG-RAN 514 and a UPF 548 (e.g., N3 interface), and an NG control plane (NG-C) interface, which is a signaling interface between the nodes of the NG-RAN 514 and an AMF 544 (e.g., N2 interface).

The NG-RAN 514 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 502 can be configured with multiple BWPs where each BWP configuration has a different SCS. When a BWP change is indicated to the UE 502, the SCS of the transmission is changed as well. Another use case example of BWP is related to power saving. In particular, multiple BWPs can be configured for the UE 502 with different amount of frequency resources (for example, PRBs) to support data transmission under different traffic loading scenarios. A BWP containing a smaller number of PRBs can be used for data transmission with small traffic load while allowing power saving at the UE 502 and in some cases at the gNB 516. A BWP containing a larger number of PRBs can be used for scenarios with higher traffic load.

The RAN 504 is communicatively coupled to CN 520 that includes network elements to provide various functions to support data and telecommunications services to customers/subscribers (for example, users of UE 502). The components of the CN 520 may be implemented in one physical node or separate physical nodes. In some embodiments, NFV may be utilized to virtualize any or all of the functions provided by the network elements of the CN 520 onto physical compute/storage resources in servers, switches, etc. A logical instantiation of the CN 520 may be referred to as a network slice, and a logical instantiation of a portion of the CN 520 may be referred to as a network sub-slice.

In some embodiments, the CN 520 may be an LTE CN 522, which may also be referred to as an EPC. The LTE CN 522 may include MME 524, SGW 526, SGSN 528, HSS 530, PGW 532, and PCRF 534 coupled with one another over interfaces (or “reference points”) as shown. Functions of the elements of the LTE CN 522 may be briefly introduced as follows.

The MME 524 may implement mobility management functions to track a current location of the UE 502 to facilitate paging, bearer activation/deactivation, handovers, gateway selection, authentication, etc.

The SGW 526 may terminate an SI interface toward the RAN and route data packets between the RAN and the LTE CN 522. The SGW 526 may be a local mobility anchor point for inter-RAN node handovers and also may provide an anchor for inter-3GPP mobility. Other responsibilities may include lawful intercept, charging, and some policy enforcement.

The SGSN 528 may track a location of the UE 502 and perform security functions and access control. In addition, the SGSN 528 may perform inter-EPC node signaling for mobility between different RAT networks; PDN and S-GW selection as specified by MME 524; MME selection for handovers; etc. The S3 reference point between the MME 524 and the SGSN 528 may enable user and bearer information exchange for inter-3GPP access network mobility in idle/active states.

The HSS 530 may include a database for network users, including subscription-related information to support the network entities' handling of communication sessions. The HSS 530 can provide support for routing/roaming, authentication, authorization, naming/addressing resolution, location dependencies, etc. An S6a reference point between the HSS 530 and the MME 524 may enable transfer of subscription and authentication data for authenticating/authorizing user access to the LTE CN 520.

The PGW 532 may terminate an SGi interface toward a data network (DN) 536 that may include an application/content server 538. The PGW 532 may route data packets between the LTE CN 522 and the data network 536. The PGW 532 may be coupled with the SGW 526 by an S5 reference point to facilitate user plane tunneling and tunnel management. The PGW 532 may further include a node for policy enforcement and charging data collection (for example, PCEF). Additionally, the SGi reference point between the PGW 532 and the data network 536 may be an operator external public, a private PDN, or an intra-operator packet data network, for example, for provision of IMS services. The PGW 532 may be coupled with a PCRF 534 via a Gx reference point.

The PCRF 534 is the policy and charging control element of the LTE CN 522. The PCRF 534 may be communicatively coupled to the app/content server 538 to determine appropriate QoS and charging parameters for service flows. The PCRF 532 may provision associated rules into a PCEF (via Gx reference point) with appropriate TFT and QCI.

In some embodiments, the CN 520 may be a 5GC 540. The 5GC 540 may include an AUSF 542, AMF 544, SMF 546, UPF 548, NSSF 550, NEF 552, NRF 554, PCF 556, UDM 558, and AF 560 coupled with one another over interfaces (or “reference points”) as shown. Functions of the elements of the 5GC 540 may be briefly introduced as follows.

The AUSF 542 may store data for authentication of UE 502 and handle authentication-related functionality. The AUSF 542 may facilitate a common authentication framework for various access types. In addition to communicating with other elements of the 5GC 540 over reference points as shown, the AUSF 542 may exhibit an Nausf service-based interface.

The AMF 544 may allow other functions of the 5GC 540 to communicate with the UE 502 and the RAN 504 and to subscribe to notifications about mobility events with respect to the UE 502. The AMF 544 may be responsible for registration management (for example, for registering UE 502), connection management, reachability management. mobility management, lawful interception of AMF-related events, and access authentication and authorization. The AMF 544 may provide transport for SM messages between the UE 502 and the SMF 546, and act as a transparent proxy for routing SM messages. AMF 544 may also provide transport for SMS messages between UE 502 and an SMSF. AMF 544 may interact with the AUSF 542 and the UE 502 to perform various security anchor and context management functions. Furthermore, AMF 544 may be a termination point of a RAN CP interface, which may include or be an N2 reference point between the RAN 504 and the AMF 544; and the AMF 544 may be a termination point of NAS (N1) signaling, and perform NAS ciphering and integrity protection. AMF 544 may also support NAS signaling with the UE 502 over an N3 IWF interface.

The SMF 546 may be responsible for SM (for example, session establishment, tunnel management between UPF 548 and AN 508); UE IP address allocation and management (including optional authorization); selection and control of UP function; configuring traffic steering at UPF 548 to route traffic to proper destination; termination of interfaces toward policy control functions; controlling part of policy enforcement, charging, and QoS; lawful intercept (for SM events and interface to L1 system); termination of SM parts of NAS messages; downlink data notification; initiating AN specific SM information, sent via AMF 544 over N2 to AN 508; and determining SSC mode of a session. SM may refer to management of a PDU session, and a PDU session or “session” may refer to a PDU connectivity service that provides or enables the exchange of PDUs between the UE 502 and the data network 536.

The UPF 548 may act as an anchor point for intra-RAT and inter-RAT mobility, an external PDU session point of interconnect to data network 536, and a branching point to support multi-homed PDU session. The UPF 548 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 548 may include an uplink classifier to support routing traffic flows to a data network.

The NSSF 550 may select a set of network slice instances serving the UE 502. The NSSF 550 may also determine allowed NSSAI and the mapping to the subscribed S-NSSAIs, if needed. The NSSF 550 may also determine the AMF set to be used to serve the UE 502, or a list of candidate AMFs based on a suitable configuration and possibly by querying the NRF 554. The selection of a set of network slice instances for the UE 502 may be triggered by the AMF 544 with which the UE 502 is registered by interacting with the NSSF 550, which may lead to a change of AMF. The NSSF 550 may interact with the AMF 544 via an N22 reference point; and may communicate with another NSSF in a visited network via an N31 reference point (not shown). Additionally, the NSSF 550 may exhibit an Nnssf service-based interface.

The NEF 552 may securely expose services and capabilities provided by 3GPP network functions for third party, internal exposure/re-exposure, AFs (e.g., AF 560), edge computing or fog computing systems, etc. In such embodiments, the NEF 552 may authenticate, authorize, or throttle the AFs. NEF 552 may also translate information exchanged with the AF 560 and information exchanged with internal network functions. For example, the NEF 552 may translate between an AF-Service-Identifier and an internal 5GC information. NEF 552 may also receive information from other NFs based on exposed capabilities of other NFs. This information may be stored at the NEF 552 as structured data, or at a data storage NF using standardized interfaces. The stored information can then be re-exposed by the NEF 552 to other NFs and AFs, or used for other purposes such as analytics. Additionally, the NEF 552 may exhibit an Nnef service-based interface.

The NRF 554 may support service discovery functions, receive NF discovery requests from NF instances, and provide the information of the discovered NF instances to the NF instances. NRF 554 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 554 may exhibit the Nnrf service-based interface.

The PCF 556 may provide policy rules to control plane functions to enforce them, and may also support unified policy framework to govern network behavior. The PCF 556 may also implement a front end to access subscription information relevant for policy decisions in a UDR of the UDM 558. In addition to communicating with functions over reference points as shown, the PCF 556 exhibit an Npcf service-based interface.

The UDM 558 may handle subscription-related information to support the network entities' handling of communication sessions, and may store subscription data of UE 502. For example, subscription data may be communicated via an N8 reference point between the UDM 558 and the AMF 544. The UDM 558 may include two parts, an application front end and a UDR. The UDR may store subscription data and policy data for the UDM 558 and the PCF 556, and/or structured data for exposure and application data (including PFDs for application detection, application request information for multiple UEs 502) for the NEF 552. The Nudr service-based interface may be exhibited by the UDR to allow the UDM 558, PCF 556, and NEF 552 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 558 may exhibit the Nudm service-based interface.

The AF 560 may provide application influence on traffic routing, provide access to NEF, and interact with the policy framework for policy control.

In some embodiments, the 5GC 540 may enable edge computing by selecting operator/3rd party services to be geographically close to a point that the UE 502 is attached to the network. This may reduce latency and load on the network. To provide edge-computing implementations, the 5GC 540 may select a UPF 548 close to the UE 502 and execute traffic steering from the UPF 548 to data network 536 via the N6 interface. This may be based on the UE subscription data, UE location, and information provided by the AF 560. In this way, the AF 560 may influence UPF (re)selection and traffic routing. Based on operator deployment, when AF 560 is considered to be a trusted entity, the network operator may permit AF 560 to interact directly with relevant NFs. Additionally, the AF 560 may exhibit an Naf service-based interface.

The data network 536 may represent various network operator services, Internet access, or third party services that may be provided by one or more servers including, for example, application/content server 538.

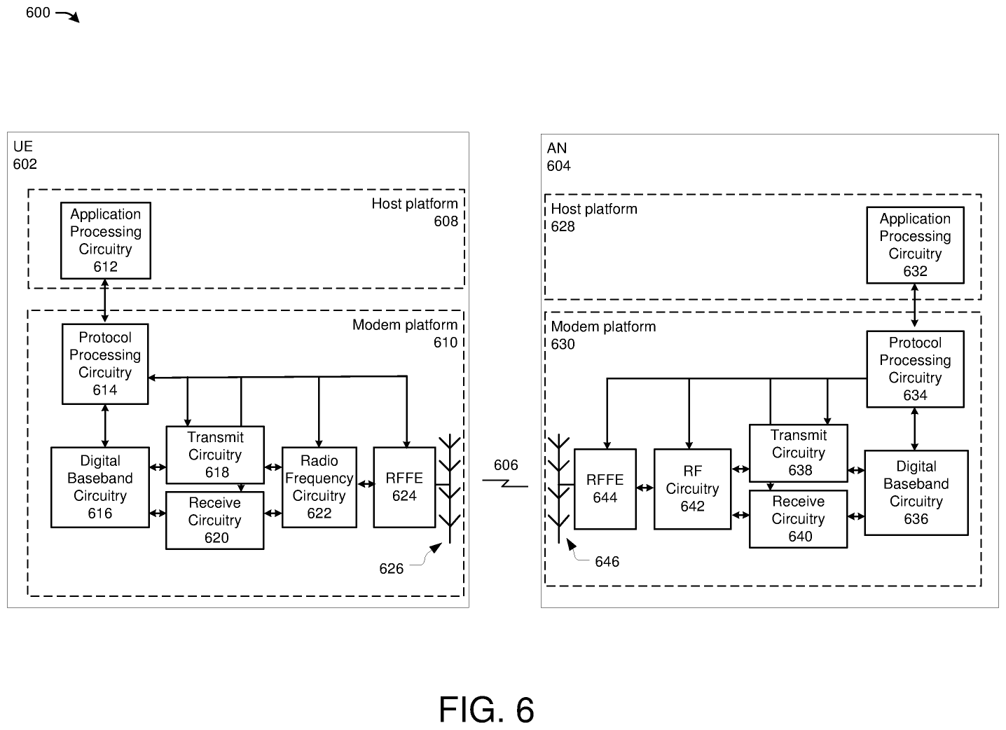

FIG. 6 schematically illustrates a wireless network 600 in accordance with various embodiments. The wireless network 600 may include a UE 602 in wireless communication with an AN 604. The UE 602 and AN 604 may be similar to, and substantially interchangeable with, like-named components described elsewhere herein.

The UE 602 may be communicatively coupled with the AN 604 via connection 606. The connection 606 is illustrated as an air interface to enable communicative coupling, and can be consistent with cellular communications protocols such as an LTE protocol or a 5G NR protocol operating at mmWave or sub-6 GHZ frequencies.

The UE 602 may include a host platform 608 coupled with a modem platform 610. The host platform 608 may include application processing circuitry 612, which may be coupled with protocol processing circuitry 614 of the modem platform 610. The application processing circuitry 612 may run various applications for the UE 602 that source/sink application data. The application processing circuitry 612 may further implement one or more layer operations to transmit/receive application data to/from a data network. These layer operations may include transport (for example UDP) and Internet (for example, IP) operations

The protocol processing circuitry 614 may implement one or more of layer operations to facilitate transmission or reception of data over the connection 606. The layer operations implemented by the protocol processing circuitry 614 may include, for example, MAC, RLC, PDCP, RRC and NAS operations.

The modem platform 610 may further include digital baseband circuitry 616 that may implement one or more layer operations that are “below” layer operations performed by the protocol processing circuitry 614 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 610 may further include transmit circuitry 618, receive circuitry 620, RF circuitry 622, and RF front end (RFFE) 624, which may include or connect to one or more antenna panels 626. Briefly, the transmit circuitry 618 may include a digital-to-analog converter, mixer, intermediate frequency (IF) components, etc.; the receive circuitry 620 may include an analog-to-digital converter, mixer, IF components, etc.; the RF circuitry 622 may include a low-noise amplifier, a power amplifier, power tracking components, etc.; RFFE 624 may include filters (for example, surface/bulk acoustic wave filters), switches, antenna tuners, beamforming components (for example, phase-array antenna components), etc. The selection and arrangement of the components of the transmit circuitry 618, receive circuitry 620, RF circuitry 622, RFFE 624, and antenna panels 626 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 614 may include one or more instances of control circuitry (not shown) to provide control functions for the transmit/receive components.

A UE reception may be established by and via the antenna panels 626, RFFE 624, RF circuitry 622, receive circuitry 620, digital baseband circuitry 616, and protocol processing circuitry 614. In some embodiments, the antenna panels 626 may receive a transmission from the AN 604 by receive-beamforming signals received by a plurality of antennas/antenna elements of the one or more antenna panels 626.

A UE transmission may be established by and via the protocol processing circuitry 614, digital baseband circuitry 616, transmit circuitry 618, RF circuitry 622, RFFE 624, and antenna panels 626. In some embodiments, the transmit components of the UE 604 may apply a spatial filter to the data to be transmitted to form a transmit beam emitted by the antenna elements of the antenna panels 626.

Similar to the UE 602, the AN 604 may include a host platform 628 coupled with a modem platform 630. The host platform 628 may include application processing circuitry 632 coupled with protocol processing circuitry 634 of the modem platform 630. The modem platform may further include digital baseband circuitry 636, transmit circuitry 638, receive circuitry 640, RF circuitry 642, RFFE circuitry 644, and antenna panels 646. The components of the AN 604 may be similar to and substantially interchangeable with like-named components of the UE 602. In addition to performing data transmission/reception as described above, the components of the AN 608 may perform various logical functions that include, for example, RNC functions such as radio bearer management, uplink and downlink dynamic radio resource management, and data packet scheduling.

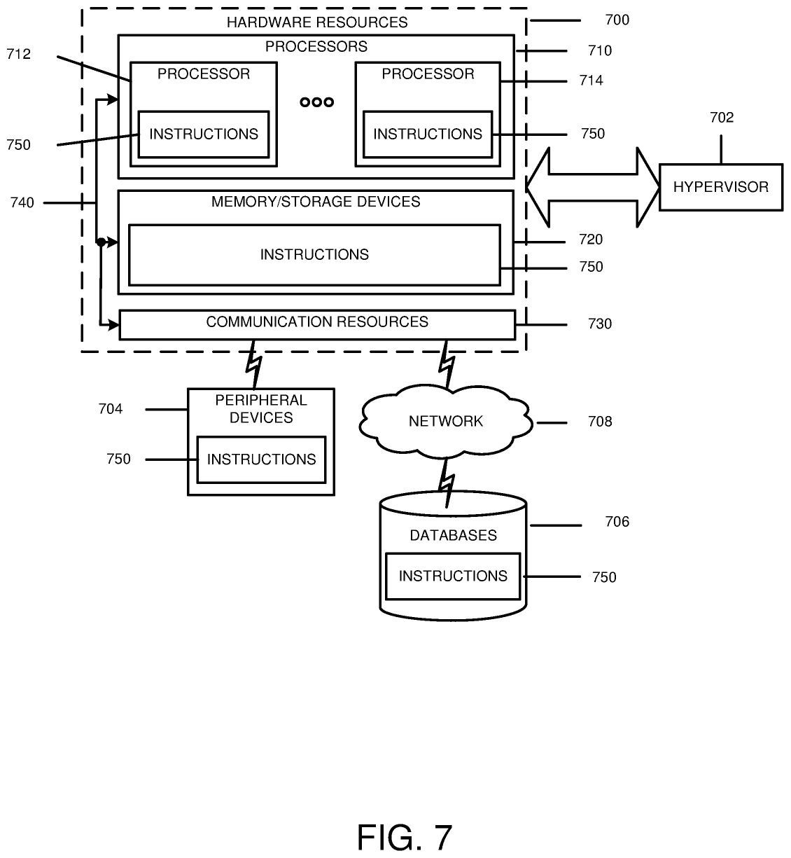

FIG. 7 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740 or other interface circuitry. For embodiments where node virtualization (e.g., NFV) is utilized, a hypervisor 702 may be executed to provide an execution environment for one or more network slices/sub-slices to utilize the hardware resources 700.

The processors 710 may include, for example, a processor 712 and a processor 714. The processors 710 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 720 may include main memory, disk storage, or any suitable combination thereof. The memory/storage devices 720 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 730 may include interconnection or network interface controllers, components, or other suitable devices to communicate with one or more peripheral devices 704 or one or more databases 706 or other network elements via a network 708. For example, the communication resources 730 may include wired communication components (e.g., for coupling via USB, Ethernet, etc.), cellular communication components, NFC components, Bluetooth® (or Bluetooth® Low Energy) components, Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

The following examples pertain to further embodiments.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first.” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Example 1 may include an apparatus of a user equipment device (UE) for unknown secondary cell activation, the apparatus comprising processing circuitry coupled to storage for storing information associated with the unknown secondary cell activation, the processing circuitry configured to: decode a medium access control (MAC) control element received from a network node, the MAC control element comprising a request to activate an unknown secondary cell (SCell); perform receiver beam sweeping using a beam sweeping factor less than eight in a frequency range prior to activating the unknown SCell, the receiver beam sweeping comprising: automatic gain control using the beam sweeping factor; and searching for the unknown SCell using the beam sweeping factor; encode a reference signal received power (RSRP) report to be transmitted, the RSRP report comprising a synchronization signal block (SSB) prior to activating the unknown SCell; perform a channel status information measurement prior to activating the unknown SCell; encode a report indicative of the channel status information measurement to be transmitted prior to activating the unknown SCell; and activate the unknown SCell.

Example 2 may include the apparatus of example 1 and/or any other example herein, wherein the frequency range is 24250-52600 MHZ.

Example 3 may include the apparatus of example 1 and/or any other example herein, wherein the frequency range is 410-725 MHz.

Example 4 may include the apparatus of example 1 and/or any other example herein, wherein the beam sweeping factor is 1, 2, 4, or 6.

Example 5 may include the apparatus of example 1 and/or any other example herein, wherein the receiver beam sweeping consists of fewer than eight samples.

Example 6 may include the apparatus of example 5 and/or any other example herein, wherein the automatic gain control consists of one sample.

Example 7 may include the apparatus of example 1 and/or any other example herein, wherein the processing circuitry is further configured to: determine to skip a layer-one RSRP measurement prior to activating the unknown SCell, wherein the RSRP report further comprises an indication of layer-three measurement.

Example 8 may include the apparatus of example 1 and/or any other example herein, wherein the processing circuitry is further configured to: determine to skip activation of a transmission configuration indicator (TCI) prior to activating the unknown SCell.

Example 9 may include the apparatus of example 8 and/or any other example herein, wherein there is no active serving cell in the frequency range, and wherein the MAC control element further comprises a channel status information reference signal (CSI-RS).

Example 10 may include the apparatus of example 1 and/or any other example herein, wherein the processing circuitry is further configured to: determine to skip fine timing tracking prior to activating the unknown SCell.

Example 11 may include the apparatus of example 1 and/or any other example herein, wherein a time delay between decoding the MAC control element and activating the unknown SCell is based on a sum of a first time delay for the automatic gain control and a second time delay for the searching for the unknown SCell.

Example 12 may include the apparatus of example 1 and/or any other example herein, wherein the processing circuitry is further configured to: determine a total time delay between decoding the MAC control element and activating the unknown SCell; and encode an indication of the total time delay to be transmitted.

Example 13 may include the apparatus of example 1 and/or any other example herein, wherein the MAC control element further comprises a semi-persistent channel status information reference signal (CSI-RS) or a radio resource control (RRC)-based CSI-RS command.

Example 14 may include the apparatus of example 1 and/or any other example herein, wherein the processing circuitry is further configured to: decode comprises a semi-persistent channel status information reference signal (CSI-RS) or a radio resource control (RRC)-based CSI-RS command, received from the network after the request to activate the unknown SCell.

Example 15 may include the apparatus of example 1 and/or any other example herein, wherein a time for performing the automatic gain control and the searching for the unknown SCell is based on the beam sweeping factor.

Example 16 may include a computer-readable storage medium comprising instructions to cause processing circuitry of a user equipment device (UE) for unknown secondary cell activation, upon execution of the instructions by the processing circuitry, to: decode a medium access control (MAC) control element received from a network node, the MAC control element comprising a request to activate an unknown secondary cell (SCell); perform receiver beam sweeping using a beam sweeping factor less than eight in a frequency range prior to activating the unknown SCell, the receiver beam sweeping comprising: automatic gain control using the beam sweeping factor; and searching for the unknown SCell using the beam sweeping factor; encode a reference signal received power (RSRP) report to be transmitted, the RSRP report comprising a synchronization signal block (SSB) prior to activating the unknown SCell; perform a channel status information measurement prior to activating the unknown SCell; encode a report indicative of the channel status information measurement to be transmitted prior to activating the unknown SCell; and activate the unknown SCell.

Example 17 may include the computer-readable medium of example 16 and/or any other example herein, wherein the beam sweeping factor is 1, 2, 4, or 6.

Example 18 may include the computer-readable medium of example 16 and/or any other example herein, wherein the receiver beam sweeping consists of fewer than eight samples.

Example 19 may include the computer-readable medium of example 18 and/or any other example herein, wherein the automatic gain control consists of one sample.

Example 20 may include the computer-readable medium of example 16 and/or any other example herein, wherein execution of the instructions further causes the processing circuitry to: determine to skip a layer-one RSRP measurement prior to activating the unknown SCell, wherein the RSRP report further comprises an indication of layer-three measurement.

Example 21 may include the computer-readable medium of example 16 and/or any other example herein, wherein execution of the instructions further causes the processing circuitry to: determine to skip activation of a transmission configuration indicator (TCI) prior to activating the unknown SCell.

Example 22 may include the computer-readable medium of example 21 and/or any other example herein, wherein there is no active serving cell in the frequency range, and wherein the MAC control element further comprises a channel status information reference signal (CSI-RS).

Example 23 may include a method for unknown secondary cell activation, the method comprising: decoding, by processing circuitry of a user equipment device (UE), a medium access control (MAC) control element received from a network node, the MAC control element comprising a request to activate an unknown secondary cell (SCell); performing, by the processing circuitry, receiver beam sweeping using a beam sweeping factor less than eight in a frequency range prior to activating the unknown SCell, the receiver beam sweeping comprising: automatic gain control using the beam sweeping factor; and searching for the unknown SCell using the beam sweeping factor; encoding, by the processing circuitry, a reference signal received power (RSRP) report to be transmitted, the RSRP report comprising a synchronization signal block (SSB) prior to activating the unknown SCell; performing, by the processing circuitry, a channel status information measurement prior to activating the unknown SCell; encoding, by the processing circuitry, a report indicative of the channel status information measurement to be transmitted prior to activating the unknown SCell; and activating, by the processing circuitry, the unknown SCell.

Example 24 may include an apparatus comprising means for: decoding, by a user equipment device (UE), a medium access control (MAC) control element received from a network node, the MAC control element comprising a request to activate an unknown secondary cell (SCell); performing receiver beam sweeping using a beam sweeping factor less than eight in a frequency range prior to activating the unknown SCell, the receiver beam sweeping comprising: automatic gain control using the beam sweeping factor; and searching for the unknown SCell using the beam sweeping factor; encoding a reference signal received power (RSRP) report to be transmitted, the RSRP report comprising a synchronization signal block (SSB) prior to activating the unknown SCell; performing a channel status information measurement prior to activating the unknown SCell; encoding a report indicative of the channel status information measurement to be transmitted prior to activating the unknown SCell; and activating the unknown SCell.

Example 25 may include one or more non-transitory computer-readable media comprising instructions to cause an electronic device, upon execution of the instructions by one or more processors of the electronic device, to perform one or more elements of a method described in or related to any of examples 1-24, or any other method or process described herein.

Example 26 may include an apparatus comprising logic, modules, and/or circuitry to perform one or more elements of a method described in or related to any of examples 1-24, or any other method or process described herein.

Example 27 may include a method, technique, or process as described in or related to any of examples 1-24, or portions or parts thereof.

Example 28 may include an apparatus comprising: one or more processors and one or more computer readable media comprising instructions that, when executed by the one or more processors, cause the one or more processors to perform the method, techniques, or process as described in or related to any of examples 1-24, or portions thereof.

Example 29 may include a method of communicating in a wireless network as shown and described herein.

Example 30 may include a system for providing wireless communication as shown and described herein.

Example 31 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019-06) and/or any other 3GPP standard. For the purposes of the present document, the following abbreviations (shown in Table 2) may apply to the examples and embodiments discussed herein.

TABLE 2
Abbreviations

| | |
|---|---|
| 3GPP | Third Generation |
| | Partnership Project |
| 4G | Fourth Generation |
| 5G | Fifth Generation |
| 5GC | 5G Core network |
| AC | Application Client |
| ACK | Acknowledgement |
| ACID | Application Client |
| | Identification |
| AF | Application Function |
| AM | Acknowledged Mode |
| AMBR | Aggregate Maximum Bit |
| | Rate |
| AMF | Access and Mobility |
| | Management Function |
| AN | Access Network |
| ANR | Automatic Neighbour |
| | Relation |
| AP | Application Protocol, |
| | Antenna Port, Access |
| | Point |
| API | Application Programming |
| | Interface |
| APN | Access Point Name |
| ARP | Allocation and Retention |
| | Priority |
| ARQ | Automatic Repeat Request |
| AS | Access Stratum |
| ASP | Application Service |
| | Provider |
| ASN.1 | Abstract Syntax Notation |
| | One |
| AUSF | Authentication Server |
| | Function |
| AWGN | Additive White Gaussian |
| | Noise |
| BAP | Backhaul Adaptation |
| | Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote |
| | Access Server |
| BSS | Business Support System |
| BS | Base Station |
| BSR | Buffer Status Report |
| BW | Bandwidth |
| BWP | Bandwidth Part |
| C-RNTI | Cell Radio Network |
| | Temporary Identity |
| CA | Carrier Aggregation, |
| | Certification Authority |
| CAPEX | CAPital EXpenditure |
| CBRA | Contention Based Random |
| | Access |
| CC | Component Carrier, |
| | Country Code, |
| | Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple |
| | Access |
| CFRA | Contention Free Random |
| | Access |
| CG | Cell Group |
| CGF | Charging Gateway |
| | Function |
| CHF | Charging Function |
| CI | Cell Identity |
| CID | Cell-ID (e.g., positioning |
| | method) |
| CIM | Common Information |
| | Model |
| CIR | Carrier to Interference |
| | Ratio |
| CK | Cipher Key |
| CM | Connection Management, |
| | Conditional Mandatory |
| CMAS | Commercial Mobile Alert |
| | Service |
| CMD | Command |
| CMS | Cloud Management |
| | System |
| CO | Conditional Optional |
| CoMP | Coordinated Multi-Point |
| CORESET | Control Resource Set |
| COTS | Commercial Off-The- |
| | Shelf |
| CP | Control Plane, Cyclic |
| | Prefix, Connection Point |
| CPD | Connection Point |
| | Descriptor |
| CPE | Customer Premise |
| | Equipment |
| CPICH | Common Pilot Channel |
| CQI | Channel Quality Indicator |
| CPU | CSI processing unit, |
| | Central Processing Unit |
| C/R | Command/Response field |
| | bit |
| CRAN | Cloud Radio Access |
| | Network, Cloud RAN |
| CRB | Common Resource Block |
| CRC | Cyclic Redundancy Check |
| CRI | Channel-State Information |
| | Resource Indicator, CSI- |
| | RS Resource Indicator |
| C-RNTI | Cell RNTI |
| CS | Circuit Switched |
| CSAR | Cloud Service Archive |
| CSI | Channel-State Information |
| CSI-IM | CSI Interference |
| | Measurement |
| CSI-RS | CSI Reference Signal |
| CSI-RSRP | CSI reference signal |
| | received power |
| CSI-RSRQ | CSI reference signal |
| | received quality |
| CSI-SINR | CSI signal-to-noise and |
| | interference ratio |
| CSMA | Carrier Sense Multiple |
| | Access |
| CSMA/CA | CSMA with collision |
| | avoidance |
| CSS | Common Search Space, |
| | Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct |
| | Current |
| DCI | Downlink Control |
| | Information |
| DF | Deployment Flavour |
| DL | Downlink |
| DMTF | Distributed Management |
| | Task Force |
| DPDK | Data Plane Development |
| | Kit |
| DM-RS, DMRS | Demodulation |
| | Reference Signal |
| DN | Data network |
| DNN | Data Network Name |
| DNAI | Data Network Access |
| | Identifier |
| DRB | Data Radio Bearer |
| DRS | Discovery Reference |
| | Signal |
| DRX | Discontinuous Reception |
| DSL | Domain Specific |
| | Language. Digital |
| | Subscriber Line |
| DSLAM | DSL Access Multiplexer |
| DwPTS | Downlink Pilot Time Slot |
| E-LAN | Ethernet Local Area |
| | Network |
| E2E | End-to-End |
| ECCA | extended clear channel |
| | assessment, extended |
| | CCA |
| ECCE | Enhanced Control |
| | Channel Element, |
| | Enhanced CCE |
| ED | Energy Detection |
| EDGE | Enhanced Datarates for |
| | GSM Evolution (GSM |
| | Evolution) |
| EAS | Edge Application Server |
| EASID | Edge Application Server |
| | Identification |
| ECS | Edge Configuration Server |
| ECSP | Edge Computing Service |
| | Provider |
| EDN | Edge Data Network |
| EEC | Edge Enabler Client |
| EECID | Edge Enabler Client |
| | Identification |
| EES | Edge Enabler Server |
| EESID | Edge Enabler Server |
| | Identification |
| EHE | Edge Hosting |
| | Environment |
| EGMF | Exposure Governance |
| | tableManagement |
| | Function |
| EGPRS | Enhanced GPRS |
| EIR | Equipment Identity |
| | Register |
| eLAA | enhanced Licensed |
| | Assisted Access, enhanced |
| | LAA |
| EM | Element Manager |
| eMBB | Enhanced Mobile |
| | Broadband |
| EMS | Element Management |
| | System |
| eNB | evolved NodeB, E- |
| | UTRAN Node B |
| EN-DC | E-UTRA-NR Dual |
| | Connectivity |
| EPC | Evolved Packet Core |
| EPDCCH | enhanced PDCCH, |
| | enhanced Physical |
| | Downlink Control Cannel |
| EPRE | Energy per resource |
| | element |
| EPS | Evolved Packet System |
| EREG | enhanced REG, enhanced |
| | resource element groups |
| ETSI | European |
| | Telecommunications |
| | Standards Institute |
| ETWS | Earthquake and Tsunami |
| | Warning System |
| eUICC | embedded UICC, |
| | embedded Universal |
| | Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control |
| | CHannel |
| FACCH/F | Fast Associated Control |
| | Channel/Full rate |
| FACCH/H | Fast Associated Control |
| | Channel/Half rate |
| FACH | Forward Access Channel |
| FAUSCH | Fast Uplink Signalling |
| | Channel |
| FB | Functional Block |
| FBI | Feedback Information |
| FCC | Federal Communications |
| | Commission |
| FCCH | Frequency Correction |
| | CHannel |
| FDD | Frequency Division |
| | Duplex |
| FDM | Frequency Division |
| | Multiplex |
| FDMA | Frequency Division |
| | Multiple Access |
| FE | Front End |
| FEC | Forward Error Correction |
| FFS | For Further Study |
| FFT | Fast Fourier |
| | Transformation |
| feLAA | further enhanced Licensed |
| | Assisted Access, further |
| | enhanced LAA |
| FN | Frame Number |
| FPGA | Field-Programmable Gate |
| | Array |
| FR | Frequency Range |
| FQDN | Fully Qualified Domain |
| | Name |
| G-RNTI | GERAN Radio Network |
| | Temporary Identity |
| GERAN | GSM EDGE RAN, GSM |
| | EDGE Radio Access |
| | Network |
| GGSN | Gateway GPRS Support |
| | Node |
| GLONASS | GLObal'naya |
| | NAvigatsionnaya |
| | Sputnikovaya Sistema |
| | (Engl.: Global Navigation |
| | Satellite System) |
| gNB | Next Generation NodeB |
| gNB-CU | gNB-centralized unit, Next |
| | Generation NodeB |
| | centralized unit |
| gNB-DU | gNB-distributed unit, Next |
| | Generation NodeB |
| | distributed unit |
| GNSS | Global Navigation |
| | Satellite System |
| GPRS | General Packet Radio |
| | Service |
| GPSI | Generic Public |
| | Subscription Identifier |
| GSM | Global System for Mobile |
| | Communications, Groupe |
| | Spécial Mobile |
| GTP | GPRS Tunneling Protocol |
| GTP-U | GPRS Tunnelling Protocol |
| | for User Plane |
| GTS | Go To Sleep Signal |
| | (related to WUS) |
| GUMMEI | Globally Unique MME |
| | Identifier |
| GUTI | Globally Unique |
| | Temporary UE Identity |
| HARQ | Hybrid ARQ, Hybrid |
| | Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile |
| | Network |
| HSDPA | High Speed Downlink |
| | Packet Access |
| HSN | Hopping Sequence |
| | Number |
| HSPA | High Speed Packet Access |
| HSS | Home Subscriber Server |
| HSUPA | High Speed Uplink Packet |
| | Access |
| HTTP | Hyper Text Transfer |
| | Protocol |
| HTTPS | Hyper Text Transfer |
| | Protocol Secure (https is |
| | http/1.1 over SSL, i.e. port |
| | 443) |
| I-Block | Information Block |
| ICCID | Integrated Circuit Card |
| | Identification |
| IAB | Integrated Access and |
| | Backhaul |
| ICIC | Inter-Cell Interference |
| | Coordination |
| ID | Identity, identifier |
| IDFT | Inverse Discrete Fourier |
| | Transform |
| IE | Information element |
| IBE | In-Band Emission |
| IEEE | Institute of Electrical |
| | and Electronics |
| | Engineers |
| IEI | Information Element |
| | Identifier |
| IEIDL | Information Element |
| | Identifier Data Length |
| IETF | Internet Engineering |
| | Task Force |
| IF | Infrastructure |
| IM | Interference |
| | Measurement, |
| | Intermodulation, IP |
| | Multimedia |
| IMC | IMS Credentials |
| IMEI | International Mobile |
| | Equipment Identity |
| IMGI | International mobile |
| | group identity |
| IMPI | IP Multimedia Private |
| | Identity |
| IMPU | IP Multimedia PUblic |
| | identity |
| IMS | IP Multimedia |
| | Subsystem |
| IMSI | International Mobile |
| | Subscriber Identity |
| IoT | Internet of Things |
| IP | Internet Protocol |
| Ipsec | IP Security, Internet |
| | Protocol Security |
| IP-CAN | IP-Connectivity |
| | Access Network |
| IP-M | IP Multicast |
| IPv4 | Internet Protocol |
| | Version 4 |
| IPv6 | Internet Protocol |
| | Version 6 |
| IR | Infrared |
| IS | In Sync |
| IRP | Integration Reference |
| | Point |
| ISDN | Integrated Services |
| | Digital Network |
| ISIM | IM Services Identity |
| | Module |
| ISO | International |
| | Organisation for |
| | Standardisation |
| ISP | Internet Service |
| | Provider |
| IWF | Interworking-Function |
| I-WLAN | Interworking WLAN |
| | Constraint length of the |
| | convolutional code, USIM |
| | Individual key |
| kB | Kilobyte (1000 bytes) |
| kbps | kilo-bits per second |
| Kc | Ciphering key |
| Ki | Individual subscriber |
| | authentication key |
| KPI | Key Performance |
| | Indicator |
| KQI | Key Quality Indicator |
| KSI | Key Set Identifier |
| ksps | kilo-symbols per |
| | second |
| KVM | Kernel Virtual |
| | Machine |
| L1 | Layer 1 (physical |
| | layer) |
| L1-RSRP | Layer 1 reference |
| | signal received power |
| L2 | Layer 2 (data link |
| | layer) |
| L3 | Layer 3 (network |
| | layer) |
| LAA | Licensed Assisted |
| | Access |
| LAN | Local Area Network |
| LADN | Local Area Data |
| | Network |
| LBT | Listen Before Talk |
| LCM | LifeCycle |
| | Management |
| LCR | Low Chip Rate |
| LCS | Location Services |
| LCID | Logical Channel ID |
| LI | Layer Indicator |
| LLC | Logical Link Control, |
| | Low Layer |
| | Compatibility |
| LPLMN | Local PLMN |
| LPP | LTE Positioning |
| | Protocol |
| LSB | Least Significant Bit |
| LTE | Long Term Evolution |
| LWA | LTE-WLAN |
| | aggregation |
| LWIP | LTE/WLAN Radio |
| | Level Integration with |
| | IPsec Tunnel |
| LTE | Long Term Evolution |
| M2M | Machine-to-Machine |
| MAC | Medium Access |
| | Control (protocol |
| | layering context) |
| MAC | Message authentication |
| | code (security/encryption |
| | context) |
| MAC-A | MAC used for |
| | authentication and key |
| | agreement (TSG T |
| | WG3 context) |
| MAC-I | MAC used for data |
| | integrity of signalling |
| | messages (TSG T |
| | WG3 context) |
| MANO | Management and |
| | Orchestration |
| MBMS | Multimedia Broadcast |
| | and Multicast Service |
| MBSFN | Multimedia Broadcast |
| | multicast service |
| | Single Frequency |
| | Network |
| MCC | Mobile Country Code |
| MCG | Master Cell Group |
| MCOT | Maximum Channel |
| | Occupancy Time |
| MCS | Modulation and coding |
| | scheme |
| MDAF | Management Data |
| | Analytics Function |
| MDAS | Management Data |
| | Analytics Service |
| MDT | Minimization of Drive |
| | Tests |
| ME | Mobile Equipment |
| MeNB | master eNB |
| MER | Message Error Ratio |
| MGL | Measurement Gap |
| | Length |
| MGRP | Measurement Gap |
| | Repetition Period |
| MIB | Master Information |
| | Block, Management |
| | Information Base |
| MIMO | Multiple Input |
| | Multiple Output |
| MLC | Mobile Location |
| | Centre |
| MM | Mobility Management |
| MME | Mobility Management |
| | Entity |
| MN | Master Node |
| MNO | Mobile Network |
| | Operator |
| MO | Measurement Object, |
| | Mobile Originated |
| MPBCH | MTC Physical |
| | Broadcast CHannel |
| MPDCCH | MTC Physical |
| | Downlink Control |
| | CHannel |
| MPDSCH | MTC Physical |
| | Downlink Shared |
| | CHannel |
| MPRACH | MTC Physical |
| | Random Access |
| | CHannel |
| MPUSCH | MTC Physical Uplink |
| | Shared Channel |
| MPLS | MultiProtocol Label |
| | Switching |
| MS | Mobile Station |
| MSB | Most Significant Bit |
| MSC | Mobile Switching |
| | Centre |
| MSI | Minimum System |
| | Information, MCH |
| | Scheduling |
| | Information |
| MSID | Mobile Station |
| | Identifier |
| MSIN | Mobile Station |
| | Identification Number |
| MSISDN | Mobile Subscriber |
| | ISDN Number |
| MT | Mobile Terminated, |
| | Mobile Termination |
| MTC | Machine-Type |
| | Communications |
| mMTC | massive MTC, massive |
| | Machine-Type |
| | Communications |
| MU-MIMO | Multi User MIMO |
| MWUS | MTC wake-up signal, |
| | MTC WUS |
| NACK | Negative |
| | Acknowledgement |
| NAI | Network Access |
| | Identifier |
| NAS | Non-Access Stratum, |
| | Non-Access Stratum |
| | layer |
| NCT | Network Connectivity |
| | Topology |
| NC-JT | Non-Coherent Joint |
| | Transmission |
| NEC | Network Capability |
| | Exposure |
| NE-DC | NR-E-UTRA Dual |
| | Connectivity |
| NEF | Network Exposure |
| | Function |
| NF | Network Function |
| NFP | Network Forwarding |
| | Path |
| NFPD | Network Forwarding |
| | Path Descriptor |
| NFV | Network Functions |
| | Virtualization |
| NFVI | NFV Infrastructure |
| NFVO | NFV Orchestrator |
| NG | Next Generation, Next |
| | Gen |
| NGEN-DC | NG-RAN E-UTRA- |
| | NR Dual Connectivity |
| NM | Network Manager |
| NMS | Network Management |
| | System |
| N-PoP | Network Point of |
| | Presence |
| NMIB, N-MIB | Narrowband MIB |
| NPBCH | Narrowband Physical |
| | Broadcast CHannel |
| NPDCCH | Narrowband Physical |
| | Downlink Control |
| | CHannel |
| NPDSCH | Narrowband Physical |
| | Downlink Shared |
| | CHannel |
| NPRACH | Narrowband Physical |
| | Random Access |
| | CHannel |
| NPUSCH | Narrowband Physical |
| | Uplink Shared |
| | CHannel |
| NPSS | Narrowband Primary |
| | Synchronization Signal |
| NSSS | Narrowband |
| | Secondary |
| | Synchronization Signal |
| NR | New Radio, Neighbour |
| | Relation |
| NRF | NF Repository |
| | Function |
| NRS | Narrowband Reference |
| | Signal |
| NS | Network Service |
| NSA | Non-Standalone |
| | operation mode |
| NSD | Network Service |
| | Descriptor |
| NSR | Network Service |
| | Record |
| NSSAI | Network Slice |
| | Selection Assistance |
| | Information |
| S-NNSAI | Single-NSSAI |
| NSSF | Network Slice |
| | Selection Function |
| NW | Network |
| NWUS | Narrowband wake-up |
| | signal, Narrowband |
| | WUS |
| NZP | Non-Zero Power |
| O&M | Operation and |
| | Maintenance |
| ODU2 | Optical channel Data |
| | Unit - type 2 |
| OFDM | Orthogonal Frequency |
| | Division Multiplexing |
| OFDMA | Orthogonal Frequency |
| | Division Multiple |
| | Access |
| OOB | Out-of-band |
| OOS | Out of Sync |
| OPEX | OPerating EXpense |
| OSI | Other System |
| | Information |
| OSS | Operations Support |
| | System |
| OTA | over-the-air |
| PAPR | Peak-to-Average |
| | Power Ratio |
| PAR | Peak to Average Ratio |
| PBCH | Physical Broadcast |
| | Channel |
| PC | Power Control, |
| | Personal Computer |
| PCC | Primary Component |
| | Carrier, Primary CC |
| PCell | Primary Cell |
| PCI | Physical Cell ID, |
| | Physical Cell Identity |
| PCEF | Policy and Charging |
| | Enforcement Function |
| PCF | Policy Control |
| | Function |
| PCRF | Policy Control and |
| | Charging Rules |
| | Function |
| PDCP | Packet Data |
| | Convergence Protocol, |
| | Packet Data |
| | Convergence Protocol |
| | layer |
| PDCCH | Physical Downlink |
| | Control Channel |
| PDCP | Packet Data |
| | Convergence Protocol |
| PDN | Packet Data Network, |
| | Public Data Network |
| PDSCH | Physical Downlink |
| | Shared Channel |
| PDU | Protocol Data Unit |
| PEI | Permanent Equipment |
| | Identifiers |
| PFD | Packet Flow |
| | Description |
| P-GW | PDN Gateway |
| PHICH | Physical hybrid-ARQ |
| | indicator channel |
| PHY | Physical layer |
| PLMN | Public Land Mobile |
| | Network |
| PIN | Personal Identification |
| | Number |
| PM | Performance |
| | Measurement |
| PMI | Precoding Matrix |
| | Indicator |
| PNF | Physical Network |
| | Function |
| PNFD | Physical Network |
| | Function Descriptor |
| PNFR | Physical Network |
| | Function Record |
| POC | PTT over Cellular |
| PP, PTP | Point-to-Point |
| PPP | Point-to-Point Protocol |
| PRACH | Physical RACH |
| PRB | Physical resource |
| | block |
| PRG | Physical resource |
| | block group |
| ProSe | Proximity Services, |
| | Proximity-Based |
| | Service |
| PRS | Positioning Reference |
| | Signal |
| PRR | Packet Reception |
| | Radio |
| PS | Packet Services |
| PSBCH | Physical Sidelink |
| | Broadcast Channel |
| PSDCH | Physical Sidelink |
| | Downlink Channel |
| PSCCH | Physical Sidelink |
| | Control Channel |
| PSSCH | Physical Sidelink |
| | Shared Channel |
| PSCell | Primary SCell |
| PSS | Primary |
| | Synchronization Signal |
| PSTN | Public Switched |
| | Telephone Network |
| PT-RS | Phase-tracking |
| | reference signal |
| PTT | Push-to-Talk |
| PUCCH | Physical Uplink |
| | Control Channel |
| PUSCH | Physical Uplink Shared |
| | Channel |
| QAM | Quadrature Amplitude |
| | Modulation |
| QCI | QoS class of identifier |
| QCL | Quasi co-location |
| QFI | QoS Flow ID, QoS |
| | Flow Identifier |
| QoS | Quality of Service |
| QPSK | Quadrature |
| | (Quaternary) Phase |
| | Shift Keying |
| QZSS | Quasi-Zenith Satellite |
| | System |
| RA-RNTI | Random Access RNTI |
| RAB | Radio Access Bearer, |
| | Random Access Burst |
| RACH | Random Access |
| | Channel |
| RADIUS | Remote Authentication |
| | Dial In User Service |
| RAN | Radio Access Network |
| RAND | RANDom number |
| | (used for |
| | authentication) |
| RAR | Random Access Response |
| RAT | Radio Access |
| | Technology |
| RAU | Routing Area Update |
| RB | Resource block, Radio |
| | Bearer |
| RBG | Resource block group |
| REG | Resource Element |
| | Group |
| Rel | Release |
| REQ | REQuest |
| RF | Radio Frequency |
| RI | Rank Indicator |
| RIV | Resource indicator |
| | value |
| RL | Radio Link |
| RLC | Radio Link Control, |
| | Radio Link Control |
| | layer |
| RLC AM | RLC Acknowledged |
| | Mode |
| RLC UM | RLC Unacknowledged |
| | Mode |
| RLF | Radio Link Failure |
| RLM | Radio Link Monitoring |
| RLM-RS | Reference Signal for |
| | RLM |
| RM | Registration |
| | Management |
| RMC | Reference |
| | Measurement Channel |
| RMSI | Remaining MSI, |
| | Remaining Minimum |
| | System Information |
| RN | Relay Node |
| RNC | Radio Network |
| | Controller |
| RNL | Radio Network Layer |
| RNTI | Radio Network |
| | Temporary Identifier |
| ROHC | RObust Header |
| | Compression |
| RRC | Radio Resource |
| | Control, Radio |
| | Resource Control layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal Time |
| | difference |
| RTP | Real Time Protocol |
| RTS | Ready-To-Send |
| RTT | Round Trip Time |
| Rx | Reception, Receiving, |
| | Receiver |
| S1AP | S1 Application |
| | Protocol |
| S1-MME | S1 for the control plane |
| S1-U | S1 for the user plane |
| S-GW | Serving Gateway |
| S-RNTI | SRNC Radio Network |
| | Temporary Identity |
| S-TMSI | SAE Temporary |
| | Mobile Station |
| | Identifier |
| SA | Standalone operation |
| | mode |
| SAE | System Architecture |
| | Evolution |
| SAP | Service Access Point |
| SAPD | Service Access Point |
| | Descriptor |
| SAPI | Service Access Point |
| | Identifier |
| SCC | Secondary Component |
| | Carrier, Secondary CC |
| SCell | Secondary Cell |
| SCEF | Service Capability |
| | Exposure Function |
| SC-FDMA | Single Carrier |
| | Frequency Division |
| | Multiple Access |
| SCG | Secondary Cell Group |
| SCM | Security Context |
| | Management |
| SCS | Subcarrier Spacing |
| SCTP | Stream Control |
| | Transmission Protocol |
| SDAP | Service Data |
| | Adaptation Protocol, |
| | Service Data |
| | Adaptation Protocol |
| | layer |
| SDL | Supplementary |
| | Downlink |
| SDNF | Structured Data |
| | Storage Network |
| | Function |
| SDP | Session Description |
| | Protocol |
| SDSF | Structured Data |
| | Storage Function |
| SDU | Service Data Unit |
| SEAF | Security Anchor |
| | Function |
| SeNB | secondary eNB |
| SEPP | Security Edge |
| | Protection Proxy |
| SFI | Slot format indication |
| SFTD | Space-Frequency Time |
| | Diversity, SFN and |
| | frame timing difference |
| SFN | System Frame Number |
| SgNB | Secondary gNB |
| SGSN | Serving GPRS Support |
| | Node |
| S-GW | Serving Gateway |
| SI | System Information |
| SI-RNTI | System Information |
| | RNTI |
| SIB | System Information |
| | Block |
| SIM | Subscriber Identity |
| | Module |
| SIP | Session Initiated |
| | Protocol |
| SiP | System in Package |
| SL | Sidelink |
| SLA | Service Level |
| | Agreement |
| SM | Session Management |
| SMF | Session Management |
| | Function |
| SMS | Short Message Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| SpCell | Special Cell |
| SP-CSI-RNTI | Semi-Persistent |
| | CSI RNTI |
| SPS | Semi-Persistent |
| | Scheduling |
| SQN | Sequence number |
| SR | Scheduling Request |
| SRB | Signalling Radio |
| | Bearer |
| SRS | Sounding Reference |
| | Signal |
| SS | Synchronization Signal |
| SSB | Synchronization Signal |
| | Block |
| SSID | Service Set Identifier |
| SS/PBCH | Block |
| SSBRI | SS/PBCH Block |
| | Resource Indicator, |
| | Synchronization Signal |
| | Block Resource |
| | Indicator |
| SSC | Session and Service |
| | Continuity |
| SS-RSRP | Synchronization Signal |
| | based Reference Signal |
| | Received Power |
| SS-RSRQ | Synchronization Signal |
| | based Reference Signal |
| | Received Quality |
| SS-SINR | Synchronization Signal |
| | based Signal to Noise |
| | and Interference Ratio |
| SSS | Secondary |
| | Synchronization Signal |
| SSSG | Search Space Set |
| | Group |
| SSSIF | Search Space Set |
| | Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission |
| | Configuration Indicator |
| TCP | Transmission |
| | Communication |
| | Protocol |
| TDD | Time Division Duplex |
| TDM | Time Division Multiplexing |
| TDMA | Time Division Multiple |
| | Access |
| TE | Terminal Equipment |
| TEID | Tunnel End Point |
| | Identifier |
| TFT | Traffic Flow Template |
| TMSI | Temporary Mobile |
| | Subscriber Identity |
| TNL | Transport Network |
| | Layer |
| TPC | Transmit Power |
| | Control |
| TPMI | Transmitting Precoding |
| | Matrix Indicator |
| TR | Technical Report |
| TRP, TRxP | Transmission |
| | Reception Point |
| TRS | Tracking Reference |
| | Signal |
| TRx | Transceiver |
| TS | Technical |
| | Specifications, |
| | Technical Standard |
| TTI | Transmission Time |
| | Interval |
| Tx | Transmission, |
| | Transmitting, |
| | Transmitter |
| U-RNTI | UTRAN Radio |
| | Network Temporary |
| | Identity |
| UART | Universal |
| | Asynchronous |
| | Receiver and |
| | Transmitter |
| UCI | Uplink Control |
| | Information |
| UE | User Equipment |
| UDM | Unified Data |
| | Management |
| UDP | User Datagram |
| | Protocol |
| UDSF | Unstructured Data |
| | Storage Network |
| | Function |
| UICC | Universal Integrated |
| | Circuit Card |
| UL | Uplink |
| UM | Unacknowledged |
| | Mode |
| UML | Unified Modelling |
| | Language |
| UMTS | Universal Mobile |
| | Telecommunications |
| | System |
| UP | User Plane |
| UPF | User Plane Function |
| URI | Uniform Resource |
| | Identifier |
| URL | Uniform Resource |
| | Locator |
| URLLC | Ultra-Reliable and Low |
| | Latency |
| USB | Universal Serial Bus |
| USIM | Universal Subscriber |
| | Identity Module |
| USS | UE-specific search |
| | space |
| UTRA | UMTS Terrestrial |
| | Radio Access |
| UTRAN | Universal Terrestrial |
| | Radio Access Network |
| UwPTS | Uplink Pilot Time Slot |
| V2I | Vehicle-to- |
| | Infrastruction |
| V2P | Vehicle-to-Pedestrian |
| V2V | Vehicle-to-Vehicle |
| V2X | Vehicle-to-everything |
| VIM | Virtualized |
| | Infrastructure Manager |
| VL | Virtual Link, |
| VLAN | Virtual LAN, Virtual |
| | Local Area Network |
| VM | Virtual Machine |
| VNF | Virtualized Network |
| | Function |
| VNFFG | VNF Forwarding |
| | Graph |
| VNFFGD | VNF Forwarding |
| | Graph Descriptor |
| VNFM | VNF Manager |
| VoIP | Voice-over-IP, Voice- |
| | over-Internet Protocol |
| VPLMN | Visited Public Land |
| | Mobile Network |
| VPN | Virtual Private |
| | Network |
| VRB | Virtual Resource Block |
| WiMAX | Worldwide |
| | Interoperability for |
| | Microwave Access |
| WLAN | Wireless Local Area |
| | Network |
| WMAN | Wireless Metropolitan |
| | Area Network |
| WPAN | Wireless Personal Area |
| | Network |
| X2-C | X2-Control plane |
| X2-U | X2-User plane |
| XML | eXtensible Markup |
| | Language |
| XRES | EXpected user |
| | RESponse |
| XOR | eXclusive OR |
| ZC | Zadoff-Chu |
| ZP | Zero Po |

What is claimed is:

1. An apparatus of a user equipment device (UE) for unknown secondary cell activation, the apparatus comprising processing circuitry coupled to storage for storing information associated with the unknown secondary cell activation, the processing circuitry configured to:
decode a medium access control (MAC) control element received from a network node, the MAC control element comprising a request to activate an unknown secondary cell (SCell);
perform receiver beam sweeping using a beam sweeping factor less than eight in a frequency range prior to activating the unknown SCell, the receiver beam sweeping comprising:
automatic gain control using the beam sweeping factor; and
searching for the unknown SCell using the beam sweeping factor;
encode a reference signal received power (RSRP) report to be transmitted, the RSRP report comprising a synchronization signal block (SSB) prior to activating the unknown SCell;
perform a channel status information measurement prior to activating the unknown SCell;
encode a report indicative of the channel status information measurement to be transmitted prior to activating the unknown SCell; and
activate the unknown SCell.

2. The apparatus of claim 1, wherein the frequency range is 24250-52600 MHZ.

3. The apparatus of claim 1, wherein the frequency range is 410-725 MHz.

4. The apparatus of claim 1, wherein the beam sweeping factor is 1, 2, 4, or 6.

5. The apparatus of claim 1, wherein the receiver beam sweeping consists of fewer than eight samples.

6. The apparatus of claim 5, wherein the automatic gain control consists of one sample.

7. The apparatus of claim 1, wherein the processing circuitry is further configured to:
determine to skip a layer-one RSRP measurement prior to activating the unknown SCell, wherein the RSRP report further comprises an indication of layer-three measurement.

8. The apparatus of claim 1, wherein the processing circuitry is further configured to:
determine to skip activation of a transmission configuration indicator (TCI) prior to activating the unknown SCell.

9. The apparatus of claim 8, wherein there is no active serving cell in the frequency range, and wherein the MAC control element further comprises a channel status information reference signal (CSI-RS).

10. The apparatus of claim 1, wherein the processing circuitry is further configured to:
determine to skip fine timing tracking prior to activating the unknown SCell.

11. The apparatus of claim 1, wherein a time delay between decoding the MAC control element and activating the unknown SCell is based on a sum of a first time delay for the automatic gain control and a second time delay for the searching for the unknown SCell.

12. The apparatus of claim 1, wherein the processing circuitry is further configured to:
determine a total time delay between decoding the MAC control element and activating the unknown SCell; and
encode an indication of the total time delay to be transmitted.

13. The apparatus of claim 1, wherein the MAC control element further comprises a semi-persistent channel status information reference signal (CSI-RS) or a radio resource control (RRC)-based CSI-RS command.

14. The apparatus of claim 1, wherein the processing circuitry is further configured to:
decode comprises a semi-persistent channel status information reference signal (CSI-RS) or a radio resource control (RRC)-based CSI-RS command, received from the network after the request to activate the unknown SCell.

15. The apparatus of claim 1, wherein a time for performing the automatic gain control and the searching for the unknown SCell is based on the beam sweeping factor.

16. A non-transitory computer-readable storage medium comprising instructions to cause processing circuitry of a user equipment device (UE) for unknown secondary cell activation, upon execution of the instructions by the processing circuitry, to:
decode a medium access control (MAC) control element received from a network node, the MAC control element comprising a request to activate an unknown secondary cell (SCell);
perform receiver beam sweeping using a beam sweeping factor less than eight in a frequency range prior to activating the unknown SCell, the receiver beam sweeping comprising:
automatic gain control using the beam sweeping factor; and
searching for the unknown SCell using the beam sweeping factor;
encode a reference signal received power (RSRP) report to be transmitted, the RSRP report comprising a synchronization signal block (SSB) prior to activating the unknown SCell;
perform a channel status information measurement prior to activating the unknown SCell;
encode a report indicative of the channel status information measurement to be transmitted prior to activating the unknown SCell; and
activate the unknown SCell.

17. The non-transitory computer-readable medium of claim 16, wherein the beam sweeping factor is 1, 2, 4, or 6.

18. A method for unknown secondary cell activation, the method comprising:
decoding, by processing circuitry of a user equipment device (UE), a medium access control (MAC) control element received from a network node, the MAC control element comprising a request to activate an unknown secondary cell (SCell);
performing, by the processing circuitry, receiver beam sweeping using a beam sweeping factor less than eight in a frequency range prior to activating the unknown SCell, the receiver beam sweeping comprising:
automatic gain control using the beam sweeping factor; and
searching for the unknown SCell using the beam sweeping factor;
encoding, by the processing circuitry, a reference signal received power (RSRP) report to be transmitted, the RSRP report comprising a synchronization signal block (SSB) prior to activating the unknown SCell;
performing, by the processing circuitry, a channel status information measurement prior to activating the unknown SCell;
encoding, by the processing circuitry, a report indicative of the channel status information measurement to be transmitted prior to activating the unknown SCell; and
activating, by the processing circuitry, the unknown SCell.

19. A non-transitory computer-readable storage medium comprising instructions to perform the method of claim 18.

20. An apparatus comprising means for performing the method of claim 18.
